(19) United States
(12) Patent Application Publication
(10) Pub. No.: US 2007/0240781 A1
(43) Pub. Date: Oct. 18, 2007

(54) Syntactic Polyurethanes and the Use Thereof of for Off-Shore Shore Damping

(75) Inventors: Peter Huntemann, Stemshorn (DE); Udo Schilling, Deipholz (DE); Gabriele Lang-Wittkowski, Mannheim (DE); Ekkehard Jahns, Weinheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/579,591

(22) PCT Filed: May 17, 2005
(86) PCT No.: PCT/EP05/05332

§ 371 Date: Nov. 6, 2006

(30) Foreign Application Priority Data
May 18, 2004 (DE) 10 2004 025 031.6

(51) Int. Cl. C08L 75/00; F16L 9/14

(52) U.S. Cl. 138/146; 138/145; 521/137

(57) ABSTRACT

The invention relates to syntactic polyurethanes, obtainable by reacting a polyisocyanate component (a) with a polyol component (b), in the presence of hollow microspheres (c) and encapsulated latent heat stores (d). The invention furthermore relates to the use of the syntactic polyurethanes for insulating offshore pipes, and insulated offshore pipes as such, and other parts and apparatuses used in the offshore sector.

The invention relates to syntactic polyurethanes, obtainable by reacting a polyisocyanate component (a) with a polyol component (b) in the presence of hollow microspheres (c) and encapsulated latent heat stores (d). The invention furthermore relates to the use of the syntactic polyurethanes for insulating offshore pipes, and insulated offshore pipes as such, and other parts and apparatuses used in the offshore sector.

The term syntactic plastics includes in general plastics which contain hollow fillers. Syntactic plastics are usually used as thermal insulating coatings, owing to their advantageous compressive strength and thermal stability, preferably in the offshore sector. Applications as fireproofing material and as sound insulation material are also known.

WO 87/1070 describes a heat insulation material consisting of elastomeric plastic, such as, for example, rubber or styrene/butadiene, as a matrix, and hollow glass microspheres, the hollow glass microspheres being incorporated in an amount of 40-80% by volume.

WO 99/3922, WO 02/72701 and EP-A-896 976 describe syntactic polyurethanes which consist of polyurethane and hollow glass microspheres and are preferably used as an insulating coating for pipes in the offshore sector. The production is effected by adding hollow microspheres to one of the polyurethane system components and subsequently mixing the system components.

The use of latent heat stores for offshore insulation is furthermore known. US 6,000,438 describes a pipe which is insulated with a plurality of layers, of which one layer contains encapsulated latent heat stores. The preferred solution proposed in this publication is associated with an undesired technical effort.

In order to obtain good insulation properties of a foam system, it is advantageous to incorporate as many hollow microspheres as possible into the system. The fact that high filler contents lead to system components having high viscosities, which are frequently thixotropic and may not be pumpable and may be poorly miscible, is problematic. These problems are increased by the fact that, in the area of use of the polyurethanes, the total filler content usually has to be added to the polyol component, since the hollow glass spheres are generally not compatible with the isocyanate because impairment of the quality of the isocyanate occurs as a result of the water content and/or the alkali content at the surface of glass.

Another problem in offshore mineral oil production is that shutdown of the mineral oil to be extracted often occurs for technical reasons. The mineral oil to be extracted cools down and, in spite of insulation, blocks the pipelines.

It was an object of the invention to provide a formulation for the preparation of syntactic polyurethanes which, firstly, permits a high load of hollow microfillers and hence leads to a low overall density and, secondly, ensures the properties required for offshore insulation, such as, for example, good extensibility and a softening point of more than 150° C. Furthermore, a high degree of processing reliability is also to be achieved.

It was a further object of the invention to provide a formulation for the preparation of syntactic polyurethanes which ensure the best possible protection from the blockage of offshore mineral oil pipes on brief shutdown of production.

The object of the invention was achieved by preparing a syntactic polyurethane by reacting polyisocyanates with a special polyol formulation in the presence of hollow microspheres and encapsulated latent heat stores, in particular those latent heat stores having a specially established liquid/solid phase transition.

The invention therefore relates to a syntactic polyurethane,
obtainable by reacting
a) a polyisocyanate component with
b) a polyol component, the polyol component (b) containing two or more constituents selected from
b1) polyetherpolyols based on a difunctional initiator molecule,
b2) polyetherpolyols based on a trifunctional initiator molecule and
b3) chain extenders,
in the presence of
c) hollow microspheres and
d) encapsulated latent heat stores.

In the context of this invention, the term hollow microsphere c) is to be understood as meaning hollow organic and mineral spheres. Hollow organic spheres which may be used are, for example, hollow plastic spheres, for example of polyethylene, polypropylene, polyurethane, polystyrene or a blend thereof. The hollow mineral spheres may contain, for example, clay, aluminum silicate, glass or mixtures thereof.

The hollow spheres may have a vacuum or partial vacuum in the interior or may be filled with air, inert gases, for example nitrogen, helium or argon, or reactive gases, for example oxygen.

Usually, the hollow organic or mineral spheres have a diameter of from 1 to 1000 μm, preferably from 5 to 200 μm. Usually, the hollow organic or mineral spheres have a bulk density of from 0.1 to 0.4 g/cm³. They generally have a thermal conductivity of from 0.03 to 0.12 W/mK.

Preferably used hollow microspheres are hollow glass microspheres. In a particularly preferred embodiment, the hollow glass microspheres have a hydrostatic compressive strength of at least 20 bar. For example, 3M—Scotchlite® Glass Bubbles may be used as hollow glass microspheres.

The hollow microspheres are generally added in an amount of from 1 to 80% by weight, preferably from 2 to 50, more preferably from 5 to 35, % by weight and particularly preferably from 10 to 30% by weight, based on the total weight of the resulting syntactic polyurethane.

The following is applicable to the components a) and b):

The polyisocyanates a) used comprise the conventional aliphatic, cycloaliphatic and in particular aromatic di- and/or polyisocyanates. Toluene diisocyanate (TDI), diphenylmethane diisocyanate (MDI) and in particular mixtures of diphenylmethane diisocyanate and polyphenylenepolymethylene polyisocyanates (crude MDI) are preferably used. The isocyanates may also be modified, for example by incorporation of uretdione, carbamate, isocyanurate, carbodiimide, allophanate and in particular urethane groups.

The polyetherpolyols used in the polyol component b) are prepared by processes known from the literature, for example by anionic polymerization with alkali metal hydroxides or alkali metal alcoholates as catalysts or with the aid of double metal cyanide catalysts and with addition of at least one initiator molecule which contains bonded reactive hydrogen atoms, from one or more alkylene oxides having 2 to 4 carbon atoms in the alkylene radical. Suitable alkylene oxides are, for example, tetrahydrofuran, ethylene oxide and 1,2-propylene oxide. The alkylene oxides may be used individually, alternately in succession or as mixtures.

Mixtures of 1,2-propylene oxide and ethylene oxide are preferred, in particular ethylene oxide being used in an amount of from 10 to 50% as an ethylene oxide cap (EO cap), so that the resulting polyols comprise more than 70% of primary terminal OH groups. In a further particularly preferred embodiment, only 1,2-propylene oxide is used as the alkylene oxide.

Alcohols, amines or alkanolamines are preferred as the initiator molecules.

It is essential to the invention that the polyol component b) contain two or more constituents selected from the group consisting of

b1) polyetherpolyols based on a difunctional initiator molecule,

b2) polyetherpolyols based on a trifunctional initiator molecule and

b3) chain extenders.

Thus, mixtures of (b1) and (b2), (b1) and (b3), (b2) and (b3) and (b1), (b2) and (b3) are possible as polyol components (b).

For example, ethanediol, 1,2- and 1,3-propanediol, diethylene glycol, dipropylene glycol, 1,4-butanediol or 1,6-hexanediol or mixtures thereof can be used as difunctional initiator molecules for the preparation of the constituent (b1). Diethylene glycol or dipropylene glycol is preferably used.

In general, the alkoxylation of the constituent (b1) is carried out in such a way that the constituent (b1) has a number average molecular weight of from 400 g/mol to 3500 g/mol, preferably from 600 to 2500 g/mol, particularly preferably from 800 to 1500 g/mol.

Glycerol, trimethylolpropane or mixtures thereof are preferably used as trifunctional initiator molecules for the preparation of the constituent (b2).

In general, the alkoxylation of the constituent (b2) is carried out in such a way that the constituent (b2) has a number average molecular weight of from 400 g/mol to 8000 g/mol, preferably from 1000 to 6000 g/mol.

In a preferred embodiment, the polyol constituent (b2) comprises the constituents (b2-1) and (b2-2), each being a polyetherpolyol based on a trifunctional initiator molecule, but having different molecular weights.

The constituent (b2-1) comprises a polyetherpolyol based on a trifunctional initiator molecule having a number average molecular weight of from 400 g/mol to 3500 g/mol, preferably from 1000 to 3200 g/mol, particularly preferably from 1500 to 3000 g/mol, in particular from 1800 to 2900 g/mol.

The constituent (b2-2) is usually a polyetherpolyol based on a trifunctional initiator molecule having a number average molecular weight of more than 3500 g/mol to 8000 g/mol, preferably from 3700 to 7000 g/mol, particularly preferably from 4000 g/mol to 6000 g/mol.

The polyol component (b) may furthermore contain chain extenders as constituent (b3). Chain extenders are generally understood as meaning branched or straight-chain alcohols or amines, preferably dihydric alcohols, having a molecular weight of less than 400 g/mol, preferably less than 300 g/mol, in particular from 60 to 250 g/mol. Examples of these are ethylene glycol, 1,4-butanediol, 1,3-propanediol, diethylene glycol or dipropylene glycol. Dipropylene glycol is preferably used.

In a further embodiment, the polyol component (b) contains, as additional constituent b4), a polyetherpolyol based on an initiator molecule which is tetrafunctional or has a higher functionality. Tetrafunctional to hexafunctional initiator molecules are preferably used. Examples of suitable initiator molecules are pentaerythritol, sorbitol and sucrose.

In a further embodiment, the individual constituents of the polyol component (b) (i.e. the constituents (b1), (b2), (b3) and, if appropriate, (b4)) are chosen so that the polyol component b) has a viscosity of less than 1000 mPa·s at 25° C., preferably less than 500 mPa·s at 25° C., particularly preferably from 200 to 400 mPa·s at 25° C., measured according to DIN 53019.

In general, the individual constituents of the polyol component b) are used in the following amounts, based in each case on the total weight of the component b):

b1) in an amount of from 0 to 80% by weight, preferably from 20 to 60% by weight, particularly preferably from 30 to 50% by weight,

b2) in an amount of from 0 to 80% by weight, preferably from 20 to 60% by weight, particularly preferably from 30 to 50% by weight, and

b3) in an amount of from 0 to 30% by weight, preferably from 5 to 25% by weight, more preferably from 7 to 20% by weight, particularly preferably from 9 to 18% by weight,

but with the proviso that at least 2 constituents, selected from (b1) to (b3), are contained in the polyol component.

If constituent b2) is divided into the constituents b2-1) and b2-2), these are generally used in the following amounts, based in each case on the total weight of the component b):
b1) in an amount of from 5 to 40% by weight, preferably from 10 to 30% by weight, particularly preferably from 15 to 25% by weight,
b2) in an amount of from 5 to 40% by weight, preferably from 10 to 30% by weight, particularly preferably from 15 to 25% by weight.

If constituent b4) is used, the amount used is in general from 0.1 to 15% by weight, preferably from 1 to 10% by weight, particularly preferably from 2 to 7% by weight.

If appropriate, additives may also be added to the polyol component. Catalysts (compounds which accelerate the reaction of the isocyanate component with the polyol component), surface-active substances, dyes, pigments, hydrolysis stabilizers, antioxidants and UV stabilizers may be mentioned here by way of example.

Furthermore, the polyol component may contain thixotropic additives, such as, for example, Laromin® C 260 (dimethylmethylenebiscyclohexylamine). In general, the amount of these thixotropic additives used is from 0.1 to 3 parts by weight, based on 100 parts by weight of the polyol component (b).

Furthermore, it is possible to add the blowing agents known from the prior art to the polyol component b). However, it is preferable if the isocyanate and the polyol component contain no physical and no chemical blowing agent. It is furthermore preferable if no water is added to these components. Thus, the components a) and b) particularly preferably contain no blowing agent, apart from residual water which is contained in industrially produced polyols.

Furthermore, it is particularly preferable if the residual water content is reduced by adding water scavengers. Suitable water scavengers are, for example, zeolites. The water scavengers are used, for example, in an amount of from 0.1 to 10% by weight, based on the total weight of the polyol component b).

If, as described above, no blowing agents are used, compact polyurethanes and not polyurethane foams are obtained as a product according to the invention.

The capsules (d) containing latent heat stores are particles having a capsule core and a capsule wall. Below, these particles are referred to as microcapsules.

The capsule core contains predominantly, preferably in an amount of more than 95% by weight, latent heat store materials. The capsule wall generally contains polymeric materials. The capsule core is solid or liquid, depending on the temperature.

Latent heat store materials are, as a rule, lipophilic substances which have their solid/liquid phase transition in the temperature range from −20 to 120° C. In the context of this invention, however, latent heat store materials which have their solid/liquid phase transition in the range above about 20° C. are used. Preferably used latent heat store materials are those which have their solid/liquid phase transition in the temperature range from 20 to 150° C., preferably from 25° C. to 120° C., particularly preferably from 45° C. to 110° C., in particular from 60° C. to 100° C.

The following may be mentioned as examples of suitable substances:
aliphatic hydrocarbon compounds, such as saturated or unsaturated C₁₀-C₅₀-hydrocarbons which are branched or preferably linear, such as, for example, n-hexadecane, n-octadecane or n-eicosane, and cyclic hydrocarbons, e.g. cyclodecane;
aromatic hydrocarbon compounds, such as benzene or naphthalene, C₁-C₄₀-alkyl-substituted aromatic hydrocarbons, such as dodecylbenzene, tetradecylbenzene or decylnaphthalene;
saturated or unsaturated C₆-C₃₀-fatty acids, such as lauric, stearic, oleic or behenic acid, preferably eutectic mixtures of decanoic acid with, for example, myristic, palmitic or lauric acid;
fatty alcohols, such as lauryl, stearyl, oleyl, myristyl or cetyl alcohol;
C₆-C₃₀-fatty amines, such as decylamine, dodecylamine, tetradecylamine or hexadecylamine;
esters, such as C₁-C₁₀-alkyl esters of fatty acids, such as propyl palmitate, methyl stearate or methyl palmitate, and preferably their eutectic mixtures;
natural and synthetic waxes, such as montanic acid waxes, montanic ester waxes, carnauba wax, polyethylene wax, oxidized waxes, polyvinyl ether waxes, ethylene/vinyl acetate wax or hard waxes obtained by the Fischer-Tropsch process;
halogenated hydrocarbons, such as chloroparaffin, bromooctadecane, bromopentadecane, bromononadecane, bromoeicosane or bromodocosane.

Furthermore, mixtures of these substances are suitable provided that there is no melting point depression outside the desired range or the heat of fusion of the mixture becomes too low for an expedient application.

For example, the abovementioned halogenated hydrocarbons may be admixed as flameproofing agents. Furthermore, flameproofing agents, such as decabromodiphenyl oxide, octabromodiphenyl oxide, antimony oxide or flameproofing additives described in U.S. Pat. No. 4,797,160, may also be added.

It is furthermore advantageous to add to the substances forming capsule cores compounds which are soluble in such substances, in order thus to prevent the freezing point depression which occurs in some cases with the nonpolar substances. As described in U.S. Pat. No. 5,456,852, compounds having a melting point of from 20 to 120° C. higher than the actual core substance are advantageously used. Suitable compounds are the fatty acids, fatty alcohols, fatty amines and aliphatic hydrocarbon compounds, such as, for example, n-alkanes, mentioned above as lipophilic substances.

The capsule wall usually contains organic polymers. Preferred wall materials are thermosetting polymers, since they are very stable to aging. Thermosetting is to be understood as meaning wall materials which, owing to the high degree of crosslinking, do not soften but decompose at high temperatures. Suitable thermosetting wall materials are, for example, formaldehyde resins, polyureas and polyurethanes and highly crosslinked methacrylic ester polymers.

Formaldehyde resins are understood as meaning reaction products of formaldehyde with
triazines, such as melamine
carbamides, such as urea
phenols, such as phenol, m-cresol and resorcinol
amino and amido compounds, such as aniline, p-toluenesulfonamide, ethyleneurea and guanidine,
   or their mixtures.

Preferred formaldehyde resins are urea/formaldehyde resins, urea/resorcinol/formaldehyde resins, urea/melamine resins and melamine/formaldehyde resins. The C₁-C₄-alkyl ethers, in particular methyl ethers, of these formaldehyde resins and the mixtures with these formaldehyde resins are also preferred. Melamine/formaldehyde resins and/or the methyl ethers thereof are particularly preferred.

Capsule walls comprising polyureas and polyurethanes are likewise possible. The capsule walls form by reaction of reactants carrying NH₂ groups or OH groups with di- and/or polyisocyanates.

Preferred microcapsules are those whose capsule wall contains a methacrylic ester polymer which is preferably crosslinked. The degree of crosslinking may be achieved, for example, with an amount of crosslinking agent of 10% by weight, based on the total polymer.

The preferred microcapsules are composed of from 30 to 100% by weight, preferably from 30 to 95% by weight, of one or more C₁-C₂₄-alkyl esters of acrylic and/or methacrylic acid as monomers I. In addition, the microcapsules may simultaneously be composed of up to 80% by weight, preferably of, from 5 to 60% by weight, in particular of from 10 to 50% by weight, of one or more bi- or polyfunctional monomers as monomers II which are insoluble or sparingly soluble in water and of up to 40% by weight, preferably up to 30% by weight, of other monomers III.

Suitable monomers I are C₁-C₂₄-alkyl esters of acrylic and/or methacrylic acid. Particularly preferred monomers I are methyl, ethyl, n-propyl and n-butyl acrylate and/or the corresponding methacrylates. Isopropyl, isobutyl, sec-butyl and tert-butyl acrylate and the corresponding methacrylates are preferred. Methacrylonitrile may furthermore be mentioned. In general, the methacrylates are preferred.

Suitable monomers II are bi- or polyfunctional monomers which are insoluble or sparingly soluble in water but have good to limited solubility in the lipophilic substance. Sparing solubility is to be understood as meaning a solubility of less than 60 g/l at 20° C.

Bi- or polyfunctional monomers are understood as meaning compounds which have at least 2 nonconjugated ethylenic double bonds.

Divinyl and polyvinyl monomers which result in crosslinking of the capsule wall during the polymerization are chiefly suitable.

Preferred bifunctional monomers are the diesters of diols with acrylic acid or methacrylic acid, and furthermore the diallyl and divinyl ethers of these diols.

Preferred divinyl monomers are propanediol acrylate, butanediol acrylate, pentanediol acrylate and hexanediol acrylate and the corresponding methacrylates.

Preferred polyvinyl monomers are trimethylolpropane triacrylate and methacrylate, pentaerythrityl triallyl ether and pentaerythrityl tetraacrylate.

Suitable monomers III are other monomers, preferably monomers IIIa, such as styrene, α-methylstyrene, β-methylstyrene, butadiene, isoprene, vinyl acetate, vinyl propionate and vinylpyridine.

The water-soluble monomers IIIb, e.g. acrylonitrile, methacrylamide, acrylic acid, methacrylic acid, itaconic acid, maleic acid, maleic anhydride, N-vinylpyrrolidone, 2-hydroxyethyl acrylate and methacrylate and acrylamido-2-methylpropanesulfonic acid, are particularly preferred.

The microcapsules used in the context of this invention can be prepared by an in situ polymerization. In this process, usually a stable oil-in-water emulsion is prepared from the monomers, a free radical initiator, if appropriate a protective colloid and the lipophilic substance to be encapsulated, in which emulsion they are present as a disperse phase. The amount of the oil phase in the oil-in-water emulsion is preferably from 20 to 60% by weight.

The polymerization of the monomers is then initiated by heating, the resulting polymers forming the capsule wall which encloses the lipophilic substance.

As a rule, the polymerization is carried out at from 20 to 100° C., preferably at from 40 to 80° C. The dispersion and polymerization temperature is preferably above the melting point of the lipophilic substances. As a rule, the microcapsules are prepared in the presence of at least one organic protective colloid. A preferred procedure is described, for example, in EP 457 154.

The particle size of the microcapsules can be influenced by the preparation process. Usually, the microcapsules are present in the form of a particle distribution after the preparation process, provided that no further steps, such as, for example, sieving, are carried out. It is preferable if the mean particle diameter of the distribution (Dₘ) is from 1 to 90 μm, preferably from 2 to 50 μm, more preferably from 3 to 30 μm, particularly preferably from 4 to 20 μm, and at least 80% of the particles, based on 100% of the particles (N) present in the distribution, have a diameter which has a value of from 0.2 Dₘ to 3 Dₘ, preferably from 0.3 Dₘ to 2.5 Dₘ, particularly preferably from 0.5 Dₘ to 1.5 Dₘ.

The total number of particles (N) present in the distribution is obtained from the integral of Dₘᵢₙ to Dₘₐₓ:

$${\int }_{{D}_{min}}^{{D}_{max}} n ( D ) \cdot ⅆ D = N$$

The mean diameter Dₘ (which is also referred to as the mean value of the particle size) is defined as the arithmetic mean value of the particle size, weighted with the distribution function. Each diameter D between Dₘᵢₙ (particles having the smallest diameter occurring in the distribution) and Dₘₐₓ (particles having the largest diameter occurring in the distribution) is first multiplied by the number n(d) of particles which have these diameters, and the sum is calculated. This is described by

$${\int }_{{D}_{min}}^{{D}_{max}} D \cdot n ( D ) \cdot ⅆ D$$

In order to calculate the mean value, this sum must be divided by the total number of particles (N), i.e.

$$Dm = \frac{{\int }_{{D}_{min}}^{{D}_{max}} D \cdot n ( D ) \cdot ⅆ D}{N} = \frac{{\int }_{{D}_{min}}^{{D}_{max}} D \cdot n ( D ) \cdot ⅆ D}{{\int }_{{D}_{min}}^{{D}_{max}} n ( D ) \cdot ⅆ D}$$

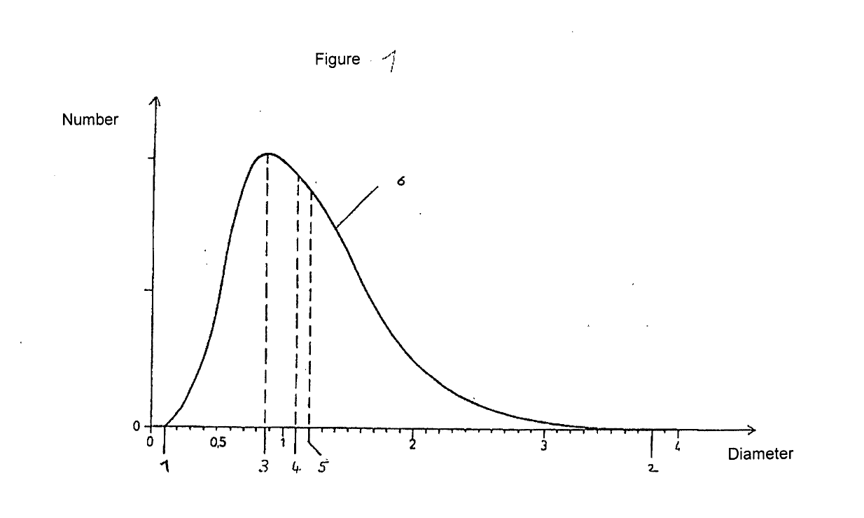

Frequently, Dₘ is also referred to as the “center of gravity” of the particle size distribution. For an illustration of Dₘ, Dₘᵢₙ and Dₘₐₓ, reference is made to FIG. 1. In FIG. 1, the meanings are as follows:

1 Dₘᵢₙ

2 Dₘₐₓ

3 Dₕ(=most frequent particle size occurring in the distribution)

4 D_{z}(=half-value diameter, divides the area into two parts of equal size)

5 Dₘ

6 n(D)

The determination of the particle sizes in the distribution was effected by dynamic light scattering according to ISO13323-1, edition: 2000-11 (Determination of particle size distribution—Single-particle light interaction methods—Part 1: Light interaction considerations) and ISO/DIS 13323-2, edition: 2000-09 (Determination of particle size distribution—Particle measurement by light scattering on individual particles—Part 2: Apparatuses and procedure for light scattering on individual particles).

In general, the encapsulated latent heat stores (d) are incorporated in an amount of from 1 to 60% by weight, preferably from 3 to 40% by weight, more preferably from 5 to 20% by weight, particularly preferably from 7 to 15% by weight, based on the total weight of the resulting syntactic polyurethane.

In addition to the syntactic polyurethanes according to the invention, the invention furthermore relates to a process for the preparation of syntactic polyurethanes by reacting
a) a polyisocyanate component with
b) a polyol component, the polyol component (b) containing two or more constituents selected from
   b1) polyetherpolyols based on a difunctional initiator molecule,
   b2) polyetherpolyols based on a trifunctional initiator molecule and
   b3) chain extenders,
in the presence of
c) hollow microspheres and
d) encapsulated latent heat stores.

Regarding the components (a) to (d) used, reference is made here to the above statements. This also applies to the additives described above.

For the preparation of the polyurethanes, the polyisocyanates a) are reacted with polyol component b) in amounts such that the ratio of the number of equivalents of NCO groups of the polyisocyanates a) to the sum of the reactive hydrogen atoms of the component b) is from 1:0.5 to 1:3.50 (corresponding to an isocyanate index of from 50 to 350), preferably from 1:0.85 to 1:1.30 and particularly preferably from 1:0.9 to 1:1.15.

The starting components are usually mixed and reacted at a temperature of from 0° C. to 100° C., preferably from 15 to 60° C. The mixing can be effected using the conventional PU processing machines. In a preferred embodiment, the mixing is effected by means of low pressure machines or high pressure machines.

The incorporation of the hollow microspheres (c) into the PU component is effected by methods known from the prior art. It is possible to add the hollow microspheres before the reaction to at least one of the components a) or b) and/or to add the hollow microspheres immediately after reaction of the components a) and b) to the still reacting reaction mixture. Examples of suitable mixing methods are described in WO 94/20286, WO 02/102887 and WO 02/072701.

The incorporation of the hollow microspheres (c) and of the encapsulated latent heat stores (d) into the PU component is effected by methods known from the prior art. It is possible to add the hollow microspheres (c) and the encapsulated latent heat stores (d) before the reaction to at least one of the components (a) or (b) and/or to add the hollow microspheres (c) and the encapsulated latent heat stores (d) immediately after reaction of the components (a) and (b) to the still reacting reaction mixture. Examples of suitable mixing methods are described in WO 94/20286, WO 02/102887 and WO 02/072701.

The invention furthermore relates to the use of the syntactic polyurethanes according to the invention for insulating offshore pipes or for the production of sockets for offshore pipes, and for the production or coating of other parts and apparatuses in the offshore sector. Examples of other parts and apparatuses in the offshore sector are well connections, pipe manifolds, pumps and buoys.

In the context of this invention, offshore pipe is understood as meaning a pipe which serves for the production of oil and gas. The oil/gas generally flows herein from the bottom of the sea to platforms, into ships/tankers or directly on land.

Sockets are to be understood as meaning the connections of two pipes or pipe sections.

The invention therefore relates to an offshore pipe, composed of
(i) an inner pipe and, adhesively mounted thereon,
(ii) a layer of syntactic polyurethanes according to the invention.

In a preferred embodiment, the layer of syntactic polyurethane according to the invention has a thickness of from 5 to 200 mm, preferably from 10 to 170 mm, particularly preferably from 15 to 150 mm.

It is furthermore possible for a further layer, for example a top layer of a thermoplastic, to be applied to the layer of polyurethane according to the invention. However, it is preferable if, in the case of the offshore pipes according to the invention, no further layer is applied to the layer (ii) of syntactic polyurethane.

Finally, the invention relates to a process for the production of offshore pipes according to the invention, comprising the steps
1) provision of an inner pipe which is to be coated with syntactic polyurethane,
2) rotation of the pipe to be coated in the axial direction,
3) application of an unreacted reaction mixture for the production of the layer of syntactic polyurethane, comprising the components a), b) and c), to the rotating pipe.

Step 3 can be effected in two different, preferred embodiments.

In a first embodiment, the application of the reaction mixture by casting onto the rotating pipe is effected in step 3). This embodiment is referred to as a rotational casting process. The reaction mixture is the polyurethane mixture according to the invention, which was obtained by mixing the components a), b), c) and d) by means of conventional mixing apparatuses, for example a low pressure mixing head. The feed of the mixing head or of the pipe is generally adjusted so that the desired thickness of the syntactic polyurethane layer is achieved with constant output. For this purpose, thixotropic additives, by means of which dripping of the reaction mixture from the rotating pipe is prevented, are preferably added to the polyol component. A suitable formulation for carrying out the rotational casting process is disclosed in the following examples under formulation 1.

In a second embodiment, step 3 can also be effected by molding: here, the reaction mixture is introduced into a closed mold which may also be heated and in which the inner pipe (i) (frequently also referred to as medium pipe) is embedded. The space between the medium pipe and the mold wall is completely filled with the reaction mixture. After curing of the polyurethane system, the mold is removed and the ready-coated pipe is present. What is important here is that the mold is completely filled without air inclusions.

The filling process can be effected from below and from above. Here, for process engineering reasons, the thixotropic additive is preferably dispensed with since the reaction mixture must remain flowable in order actually to be able to fill the mold completely. A suitable formulation for carrying out the molding process is disclosed in the following examples, under formulation 2.

The invention is to be illustrated by the examples which follow.

### EXAMPLES

Syntactic polyurethanes according to the formulations 1 and 2 and pipes coated with polyurethanes according to the invention were produced.

Formulation 1:

| | |
|---|---|
| Polyetherpolyol, difunctional initiator | 41.0 parts by weight (pbw) |
| Polyetherpolyol, trifunctional initiator, | 20.0 pbw |
| Mw 2000 | |
| Polyetherpolyol, trifunctional initiator, | 20.0 pbw |
| Mw 5000 | |
| Chain extender | 14.6 pbw |
| Laromin C 260 | 2.2 pbw |
| Catalyst (Lupragen NMI) | 0.3 pbw |
| Adhesion promoter (silane) | 0.6 pbw |
| Antifoam | 0.5 pbw |
| UOP L-Paste | 0.8 pbw |

B component: Lupranat M 20 S

C component: 3M glass bubbles type S 38 (16% total content)

D component: Latent heat store: Ceracap NB 1001 X (a microcapsule powder having a core of an n-alkane wax mixture with a melting point of 26° C. and a capsule wall of crosslinked polymethyl methacrylate).

In amounts of 5.0% by weight; 10% by weight and 20% by weight, based on the total weight of the syntactic polyurethane

The components C and D are incorporated into the A component.

The preparation of the GSPU is carried out by means of a low pressure machine.

Using formulation 1, offshore pipes were produced by the rotational casting process.

Formulation 2

| | |
|---|---|
| Polyetherpolyol, difunctional initiator | 40.61 pbw |
| Polyetherpolyol, trifunctional initiator, Mw 2000 | 41.63 pbw |
| Chain extender | 16.16 pbw |
| Catalyst | 0.50 pbw |
| Adhesion promoter (silane) | 0.60 pbw |
| Antifoam | 0.50 pbw |

B component: Lupranat M 20 S

C component: 3M glass bubbles type S 38 (16% total content)

D component: Latent heat store: Ceracap NB 1001 X (a microcapsule powder having a core of an n-alkane wax mixture with a melting point of 26° C. and a capsule wall of crosslinked polymethyl methacrylate).

In amounts of 5.0% by weight; 10% by weight and 20% by weight, based on the total weight of the syntactic polyurethane.

The components C and D are incorporated into the A component.

The preparation of the GSPU is carried out by means of a low pressure machine.

Using formulation 2, offshore pipes were produced by the molding process.

1. A syntactic polyurethane,
obtainable obtained by reacting
a) a polyisocyanate component with
b) a polyol component, the polyol component (b) containing two or more constituents selected from
b1) polyetherpolyols based on a difunctional initiator molecule,
b2) polyetherpolyols based on a trifunctional initiator molecule and
b3) chain extenders,
in the presence of
c) hollow microspheres and
d) encapsulated latent heat stores.

2. The syntactic polyurethane according to claim 1, wherein the individual constituents of the polyol component b) are chosen so that the polyol component b) has a viscosity of less than 1000 mPa·s at 25° C., measured according to DIN 53019.

3. The syntactic polyurethane according to claim 1, wherein the constituents
b1) are present in an amount of from 20 to 60% by weight,
b2) are present in an amount of from 20 to 60% by weight and
b3) are present in an amount of from 5 to 25% by weight, based on the total weight of the polyol component b), in the component b).

4. The syntactic polyurethane according to claim 1, wherein a liquid/solid phase transition of the encapsulated latent heat stores (d) is in the range from 30° C. to 100° C.

5. The syntactic polyurethane according to claim 1, wherein the encapsulated latent heat stores (c) are present in the form of a particle size distribution, the mean particle diameter of the distribution (Dₘ) being from 1 to 90 μm and at least 80% of the particles, based on 100% of the particles (N) present in the distribution, having a diameter which has a value of from 0.2 Dₘ to 3 Dₘ.

6. A process for the preparation of syntactic polyurethanes by reacting
a) a polyisocyanate component with
b) a polyol component, the polyol component (b) containing two or more constituents selected from
b1) polyetherpolyols based on a difunctional initiator molecule,
b2) polyetherpolyols based on a trifunctional initiator molecule and
b3) chain extenders,
in the presence of
c) hollow microspheres and
d) encapsulated latent heat stores.

7. A method for insulating offshore pipes and/or producing sockets for offshore pipes, and for producing or coating of parts and apparatuses in the offshore sector, comprising using the syntactic polyurethane of claim 1.

8. An offshore pipe composed of
(i) an inner pipe and, adhesively mounted thereon, and
(ii) a layer of syntactic polyurethane according to claim 1.

9. The offshore pipe according to claim 8, wherein the layer (ii) of syntactic polyurethane has a thickness of from 5 to 200 mm.

10. A process for the production of offshore pipes according to claim 8, comprising the steps
1) providing an inner pipe that is to be coated with syntactic polyurethane,
2) rotating the pipe to be coated and
3) application of an unreacted reaction mixture for the production of the layer of syntactic polyurethane, comprising the components a), b) and c), to the rotating pipe.
